(19) United States
(12) Patent Application Publication
(10) Pub. No.: US 2009/0123746 A1
(43) Pub. Date: May 14, 2009

(54) ADHESIVE SHEET

(75) Inventors: Keiko TANAKA, Gunma (JP); Jun Maeda, Saitama (JP)

Correspondence Address: DITTHAVONG MORI & STEINER, P.C., 918 Prince St., Alexandria, VA, 22314, US

(73) Assignee: LINTEC Corporation, Tokyo (JP)

(21) Appl. No.: 12/268,813

(22) Filed: Nov. 11, 2008

(30) Foreign Application Priority Data
Nov. 12, 2007 (JP) 2007-293329
Oct. 23, 2008 (JP) 2008-273282

(51) Int. Cl. B32B 27/30; B32B 27/40

(52) U.S. Cl. 428/355 AC

(57) ABSTRACT

An adhesive sheet includes a substrate and an energy-ray-curable adhesive layer formed on the substrate. The energy-ray-curable adhesive layer includes an energy-ray-curable acrylic copolymer and an energy-ray-curable urethane acrylate. The energy-ray-curable acrylic copolymer includes a side chain with an unsaturated group. The energy-ray-curable urethane acrylate includes an isocyanate unit, a polyol unit, and a (meth)acryloyl group. The polyol unit includes a plurality of types of polyols.

### BACKGROUND OF THE INVENTION

1. Field of the Invention

The present invention relates to an adhesive sheet, and especially to an adhesive sheet which protects a surface of a semiconductor wafer during the grinding process in which the rear surface of the semiconductor wafer is ground.

2. Description of the Related Art

The rear surface of a semiconductor wafer is ground after circuits are formed on the front side surface thereof to reduce the thickness of the semiconductor wafer. During the grinding process, an adhesive sheet used as a protective sheet is adhered to the front surface to protect the circuits formed thereon. Such a protective sheet is required not only to prevent damage to the circuits or the wafer body, but also to prevent contamination to the circuit caused by residual adhesive matter following removal of the protective sheet. There is known an adhesive sheet including an ultraviolet-ray-curable adhesive which serves as such a protective sheet (e.g., as in Japanese unexamined Patent Publication No. S60-189938).

In regular manufacturing processes, a semiconductor wafer is diced in a dicing process after a grinding process. Recently, handling a ground wafer has become increasingly difficult in semiconductor manufacturing processes, because the diameter of the wafer has increased while the thickness of the wafer has decreased, thus the semiconductor wafer has become increasingly breakable. Therefore, the so-called DBG process (that is, dicing before grinding process), where the wafer is partially cut (in a half-cut process) before the grinding process chips the wafer, is promising. In the DBG process, a protective sheet is adhered to the circuit surface of a wafer after undergoing the half cut process (e.g., as in Japanese unexamined Patent Publication No. H05-335411).

In the DBG process, the wafer has been chipped during the grinding process. Therefore, sufficient adhesion to the front surface of each chip of a wafer is required of the protective sheet used in the DBG process, to prevent the penetration of the washing water between the chips. When the adhesiveness of a protective sheet is increased to strengthen adhesion to the circuit surface of the wafer, there is a tendency to increase the problem of adhesive residue remaining on the circuit surface after the protective sheet has been stripped away. To solve this problem, in the DBG process, it is especially important to suppress the occurrence of such an adhesive residue. Therefore, it is known that an adhesive sheet including an energy-ray-curable adhesive, such as an ultraviolet ray curable adhesive may be used as a protective sheet (e.g., as in Japanese unexamined Patent Publication No. 2000-68237).

Because the shapes of semiconductor parts have changed over time, relatively uneven elements such as electrodes tend to collect at the periphery of a semiconductor chip, that is, uneven elements tend to be concentrated in a small area. Therefore, effectively adhering a protective sheet to the edge of a semiconductor chip is becoming more difficult, so that the protective sheet that is used in the DBG process, or the one used even in a regular process, may not seal the circuit surface effectively due to poor adhesion to the circuits (followability to bond to the uneven circuit surface). As a result, a problem where water for grinding penetrates the circuit surface has arisen. Further, if contents of the energy-ray-curable adhesive between are not compatible, or the characteristics such as tensile property of the energy-ray-curable adhesive layer are not suitable, a problem where the adhesive residue is increased will arise.

### SUMMARY OF THE INVENTION

Therefore, the objective of the present invention is to provide an adhesive sheet that has sufficient followability to bond to the uneven circuit surface of a wafer and so on, sufficient compatibility between its components, and that has an excellent tensile property so that it can prevent the adhesive residue.

An adhesive sheet, according to the present invention, includes a substrate and an energy-ray-curable adhesive layer formed on the substrate. The energy-ray-curable adhesive layer includes an energy-ray-curable acrylic copolymer and an energy-ray-curable urethane acrylate. The energy-ray-curable acrylic copolymer includes a side chain with an unsaturated group. The energy-ray-curable urethane acrylate includes an isocyanate unit, a polyol unit, and a (meth)acryloyl group. The polyol unit includes a plurality of types of polyols.

The polyols may include a polypropylene glycol and a polyethylene glycol. The molar ratio of the polypropylene glycol and the polyethylene glycol may be between 9:1 and 1:9, and more preferably, between 9:1 and 1:4.

The rupture stress of the energy-ray-curable adhesive layer may be greater than or equal to 10 MPa, and the breaking elongation thereof may be greater than or equal to 15%, when the energy-ray-curable adhesive layer is cured by energy-rays.

### BRIEF DESCRIPTION OF THE DRAWINGS

The present invention will be better understood from the description of the preferred embodiment of the invention set forth below, together with the accompanying drawings in which:

FIG. 1 is a graph representing the relationship between the ratio of the PPG (polypropylene glycol) in polyols and the rupture stress (MPa) in the working examples; and

FIG. 2 is a graph representing the relationship between the ratio of the PPG (polypropylene glycol) in polyols and the breaking elongation (%) in the working examples.

### DESCRIPTION OF THE PREFERRED EMBODIMENT

Hereinafter, an adhesive sheet of the embodiment of the present invention is explained. The adhesive sheet includes a substrate, and an energy-ray-curable adhesive layer formed on the substrate. When the adhesive sheet is used, the energy-ray-curable adhesive layer is adhered to a circuit surface of a semiconductor wafer. When the semiconductor wafer is processed, for example, using the DBG process explained below, the rear surface of the semiconductor wafer is ground with the adhesive sheet adhered to the circuit surface thereof. At the time, the adhesive sheet prevents the penetration of the grinding water onto the circuit surface, and prevents the individual chips from coming into contact with each other, thus protecting the semiconductor wafer.

The energy-ray-curable adhesive layer is explained below. The energy-ray-curable adhesive layer includes primarily an energy-ray-curable acrylic copolymer and an energy-ray-curable urethane acrylate (hereinafter, occasionally named urethane acrylate). The energy-ray-curable acrylic copolymer includes a product of an acrylic copolymer and an unsaturated compound having an unsaturated group, chemically bonded to each other. The energy-ray-curable adhesive layer further includes components of a crosslinking agent and others, in addition to the energy-ray-curable acrylic copolymer and urethane acrylate.

Each component of the energy-ray-curable adhesive layer is explained below. The acrylic copolymer is a copolymer of a main monomer, a functional monomer, and so on.

The main monomer provides the fundamental characteristics for the energy-ray-curable adhesive layer to function as an adhesive layer. As a main monomer, for example, (meth)acrylic acid ester monomer, or a constitutional unit of the derivatives thereof is used. The (meth)acrylic acid ester monomers that have an alkyl group with carbon number 1 to 18, can be used. In these (meth)acrylic acid ester monomers, preferably, methyl acrylate, methyl methacrylate, ethyl acrylate, ethyl methacrylate, propyl acrylate, propyl methacrylate, butyl acrylate, butyl methacrylate, 2-ethyl hexyl acrylate, 2-ethyl hexyl methacrylate, are used. These main monomers are preferably included in 50 to 90 weight percent of all monomers to form the acrylic copolymer.

The functional monomer is used to make the unsaturated compound bondable to the acrylic copolymer and to provide a functional group which is required, as explained below, for a reaction with a crosslinking agent. That is, a functional monomer which intramolecularly consists of a polymerizing double bond and a functional group such as a hydroxyl group, a carboxyl group, an amino group, a substituted amino group, or an epoxy group. Preferably, a compound with a hydroxyl group, a carboxyl group, or the like is used.

More specific examples of the functional monomer are; (meth)acrylates with a hydroxyl group, such as 2-hydroxyethyl acrylate, 2-hydroxyethyl methacrylate, 2-hydroxypropyl acrylate, and 2-hydroxypropyl methacrylate; compounds with a carboxyl group, such as an acrylic acid, a methacrylic acid, and an itaconic acid; (meth)acrylate with an amino group, such as an N-(2-aminoethyl)acrylamide, and an N-(2-aminoethyl)methacrylamide; (meth)acrylates with a substituted amino group, such as a monomethyl aminoethyl acrylamide and a monomethyl aminoethyl methacrylamide; (meth)acrylates with an epoxy group, such as a glycidyl acrylate, and a glycidyl methacrylate. These functional monomers are preferably included in 1 to 30 weight percent of all monomers to form the acrylic copolymer, as a constitutional monomer.

The acrylic copolymer may include a dialkyl(meth)acrylamide as a constitutional monomer. The compatibility of the energy-ray curable acrylic copolymer to a urethane acrylate which has high polarity, is improved by using the dialkyl(meth)acrylamide as a constitutional monomer. As the dialkyl(meth)acrylamide, a dimethyl(meth)acrylamide, a diethyl(meth)acrylamide, and others are used, and especially preferably, a dimethyl(meth)acrylamide is used.

These dialkyl(meth)acrylamides are preferable because they include an amino group whose reactivity is restrained due to alkyl groups, effectively eliminating a negative impact on polymerization and other reactions. Furthermore, the dimethylacrylamide which has the highest polarity among these dialkyl(meth)acrylamides is especially suitable for improving the compatibility of the energy-ray curable acrylic copolymer to the urethane acrylate with high polarity. Note that dialkyl(meth)acrylamides are preferably included in 1 to 30 weight percent of the acrylic copolymer as a constitutional monomer thereof.

The acrylic copolymer is formed by a known method for copolymering the monomers explained above, that is, the main monomer, the functional monomer, and preferably with the dialkyl(meth)acrylamide. However, monomers other than these may be included in the acrylic copolymer. For example, a vinyl formate, a vinyl acetate, or a styrene may be copolymerized and included in the acrylic copolymer in the ratio of approximately or below 10 weight percent.

Next, the unsaturated compound is explained. The unsaturated compound is used to provide an energy-ray curing property to the energy-ray-curable acrylic copolymer. That is, the energy-ray-curable acrylic copolymer acquires its energy-ray curing property, due to the addition of the unsaturated compound that is polymerized by the radiation of ultraviolet ray or some other radiation. The energy-ray-curable acrylic copolymer is formed by the reaction of the acrylic copolymer which contains functional groups and is formed as explained above, together with the unsaturated compound which has substituted groups reactive to the functional groups of the acrylic copolymer.

The substituted group of the unsaturated compound is selected according to the type of functional group of the acrylic copolymer, that is, according to the type of functional group of the monomers used for forming the acrylic copolymer. For example, when the functional group of the acrylic copolymer is a hydroxyl group or a carboxyl group, the substituted group preferably is an isocyanate group or an epoxy group; when the functional group is an amino group or a substituted amino group, the substituted group preferably is an isocyanate group; and when the functional group is an epoxy group, the substituted group preferably is a carboxyl group. Such a substituted group is provided in each molecule of the unsaturated compound.

The unsaturated compound includes approximately 1 to 5 double bonds for polymerization, preferably with one or two double bonds in one molecule. The examples of such unsaturated compounds are methacryloyl oxyethyl isocyanate, meta-isopropenyl-α,α-dimethylbenzyl isocyanate, methacryloyl isocyanate, allyl isocyanate, glycidyl(meth)acrylate, (meth)acrylic acid, or so on.

The unsaturated compound is reacted with the acrylic copolymer in the ratio of approximately 20 to 100 equivalents, preferably 40 to 95 equivalents, and ideally approximately 50 to 90 equivalents of the unsaturated compound to 100 equivalents of the functional group of the acrylic copolymer. The reaction of the acrylic copolymer and the unsaturated compound is carried out under conventional conditions, such as with a catalyst in ethyl acetate that is used as a solvent, and stirred for 24 hours at room temperature under atmospheric pressure.

As a result, the functional groups in the side chains of the acrylic copolymer react with the substituted groups in the unsaturated compound, thus generating the energy-ray-curable acrylic copolymer in which unsaturated groups have been introduced to the side chains of the acrylic copolymer therein. The reaction rate of the functional groups to the substituted groups in the reaction is more than or equal to 70 percent, and preferably more than or equal to 80 percent, and a portion of unreacted unsaturated compounds may remain in the energy-ray-curable acrylic copolymer. The weight average molecular weight of the energy-ray-curable acrylic copolymer formed by the reaction explained above is preferably more than or equal to 100,000, and ideally 200,000 to 2,000,000, with the glass transition temperature thereof preferably approximately in the range of −70 to 10 degrees Celsius.

The energy-ray-curable urethane acrylate that is mixed with the energy-ray-curable acrylic copolymer is explained below. The energy-ray-curable urethane acrylate is a compound that includes an isocyanate unit, a polyol unit, and a (meth)acryloyl group at the terminal thereof. As the urethane acrylate, the following compounds can be used. Examples include a compound that is obtained by reacting a urethane oligomer and a compound having a (meth)aclyloyl group at its terminal. Such a urethane oligomer is formed by a reaction of a polyol such as an alkylene polyol, a polyether, or a polyester having hydroxy groups at the terminal thereof and a polyisocyanate. Such urethane acrylates have energy-curing properties due to the action of the (meth)aclyloyl groups.

As the polyisocyanate mentioned above, an isophorone diisocyanate (IPDI), 1,3-bis(isocyanatomethyl)cyclohexane (H6XDI), 4,4′-dicyclohexylmethane diisocyanate (H12MDI), and other diisocyanates can be used, as explained below. These polyisocyanates are included in the energy-ray-curable urethane acrylate, preferably at 40 to 49 mole percent. In these polyisocyanates, using isophorone diisocyanate (IPDI) that improves the compatibility of the energy-ray-curable urethane acrylate to the energy-ray-curable acrylic copolymer is especially preferable.

As polyols to form a polyol unit included in the energy-ray-curable urethane acrylate, a polypropylene glycol (PPG, number average molecular weight of 700), a polyethylene glycol (PEG, number average molecular weight of 600), a polytetramethylene glycol (PTMG, number average molecular weight of 850), a polycarbonate diol (PCDL, number average molecular weight of 800), and others can be used. The number average molecular weight of these polyols is preferably between 300 and 2,000, and especially preferably between 500 and 1,000. When these polyols are included in the energy-ray-curable urethane acrylate, polyols are preferably included in 20 to 48 mole percent. The polyol unit includes a plurality of types of polyols, and preferably, includes PPGs and PEGs. The most preferable polyols are PPGs and PEGs. The molar ratio of PPGs and PEGs is preferably between 9:1 and 1:9, more preferably between 9:1 and 1:4. Ideally, the molar ratio of PPGs and PEGs is between 4:1 and 3:2, and more ideally, 7.5:2.5 and 6.5:3.5.

As an acrylate to form the (meth)aclyloyl group, a 2-hydroxyethyl acrylate (2HEA), a 2-hydroxypropyl acrylate (2HPA), and others are used. These acrylates are included in the energy-ray-curable urethane acrylate, preferably at 4 to 40 mole percent.

The energy-ray-curable urethane acrylate is mixed with 100 weight parts of energy-ray-curable acrylic copolymer, preferably in the ratio of 1 to 200 weight parts of urethane acrylate, and more preferably 5 to 100 weight parts thereof, and ideally 10 to 50 weight parts thereof. The number average molecular weight of the urethane acrylate molecule is preferably in the range of 300 to 30,000, in terms of the compatibility with the energy-ray-curable acrylic copolymer and the processing properties of the energy-ray-curable adhesive layer. More preferably, the number average molecular weight of the urethane acrylate is lower than or equal to 20,000, and for example, the urethane acrylate is an oligomer whose number average molecular weight is in the range of 1,000 to 15,000.

The energy-ray-curable adhesive layer of the present invention may include a crosslinking agent. The selection of the crosslinking agent which can be bonded to the functional group derived from the functional monomer is explained below. For example, when the functional group is one which has an active hydrogen such as a hydroxyl group, a carboxyl group, or an amino group; organic polyisocyanate compounds, organic polyepoxy compounds, organic polyimine compounds, or metal chelate compounds can be selected as the crosslinking agent. Examples of the organic polyisocyanate compound are, for example, aromatic organic polyisocyanate compounds, aliphatic organic polyisocyanate compounds, alicyclic organic polyisocyanate compounds, and so on. More specific examples of the organic polyisocyanate compounds are, for example, 2,4-tolylene diisocyanate, 2,6-tolylene diisocyanate, 1,3-xylylene diisocyanate, 1,4-xylene diisocyanate, diphenylmethane 4,4′-diisocyanate, diphenylmethane 2,4′-diisocyanate, 3-methyldiphenylmethane diisocyanate, hexamethyene diisocyanate, isophorone diisocyanate, dicyclohexylmethane 4,4′-diisocyanate, dicyclohexylmethane 2,4′-diisocyanate, lysine isocyanate, and so on. In addition, trimers of these polyisocyanate compounds, and a urethane prepolymer having terminal isocyanate functions generated by reactions of these polyisocyanate compounds and polyol compounds, and others are more examples of the organic polyisocyanate compounds.

Further, specific examples of the organic polyepoxy compounds are bisphenol A type epoxy compounds, bisphenol F type epoxy compounds, 1,3-bis(N,N-diglycidyl-aminomethyl)benzene, 1,3-bis(N,N-diglycidyl-aminomethyl)toluene, N,N,N′,N′-tetraglycidyl-4,4-diaminophenyl methane, and so on. Additionally, specific examples of the organic polyimine compounds are N,N′-diphenylmethane-4,4′-bis(1-aziridine carboxamide), trimethylolpropane-tri-β-aziridinylpropionate, tetramethylolmethane-tri-β-aziridinylpropionate, N,N′-toluene-2,4-bis(1-aziridine carboxamide), triethylenemelamine, and so on. Note that the quantity of the crosslinking agent is preferably in the range of approximately 0.01 to 20 weight parts, and ideally in the range of approximately 0.1 to 10 weight parts, to the 100 weight parts of the energy-ray-curable acrylic copolymer.

When the ultraviolet ray is used for curing the energy-ray-curable acrylic copolymer, a photopolymerization initiator is added to the energy-ray-curable adhesive layer to shorten the polymerization time and reduce the dose of the ultraviolet ray. As the photopolymerization initiator, for example, benzophenone, acetophenone, benzoin, benzoin methyl ether, benzoin ethyl ether, benzoin isopropyl ether, benzoin isobutyl ether, benzoin benzoate, benzoin methyl benzoate, benzoin dimethyl ketal, 2,4-diethylthioxanthone, α-hydroxy cyclohexyl phenyl keton, benzyl diphenyl sulfide, tetramethyl thiuram monosulfide, azobisisobutyronitrile, β-chloro anthraquinone, or 2,4,6-trimethylbenzoyl diphenylphosphine oxide are used. Note that the amount of photopolymerization initiator is preferably 0.1 to 10 weight parts, and ideally approximately 0.5 to 5 weight parts, to 100 weight parts of the energy-ray-curable acrylic copolymer.

In addition to these agents, additives such as an anti-aging agent, a stabilizer, a plasticizer, a coloring agent, and so on may be formulated in the energy-ray-curable adhesive layer to meet various requirements, without any restriction on their ratios as long as the purpose of the present invention are preserved.

The energy-ray-curable adhesive layer of the above explained formulation is a mixture of different components which have relatively high molecular weights. Generally, a mixture of compounds having high molecular weights has low self-compatibility and the physical properties thereof tend to become unstable. Further, when the energy-ray-curable adhesive layer, as a mixture, has low self-compatibility, residual adhesive material tends to be left on the adherend, even when the energy-ray-curable adhesive layer is cured. On the other hand, in the energy-ray-curable adhesive layer of the present invention, the urethane acrylate of the above explained formulation has sufficient compatibility with the energy-ray-curable acrylic copolymer. Therefore, the energy-ray-curable adhesive layer has a stable adhesion property. Note that the compatibility of the energy-ray-curable adhesive layer can be evaluated by measuring the haze value, because a mixture having low compatibility is turbid and becomes hazy.

The value of the storage modulus G′ at 25 degrees Celsius of the energy-ray-curable adhesive layer, is preferably less than or equal to 0.15 MPa, while the value of the loss tangent (tan δ=loss modulus/storage modulus) at 25 degrees Celsius is preferably greater than or equal to 0.2, when the energy-ray-curable adhesive layer is not cured by energy-ray. As explained, when the value of the storage modulus G′ is less than or equal to 0.15 MPa, and the value of the loss tangent δ is greater than or equal to 0.2, the energy-ray-curable adhesive layer has sufficient followability to bond to the uneven wafer and reliably prevents penetration of grinding water onto the circuit surface.

The rupture stress of the energy-ray-curable adhesive layer that is cured by energy-ray is preferably greater than or equal to 10 MPa, and more preferably, greater than or equal to 15 MPa. Furthermore, the breaking elongation of the cured energy-ray-curable adhesive layer is preferably greater than or equal to 15%, and more preferably, greater than or equal to 20%. As explained above, when the rupture stress is greater than or equal to 10 MPa and the breaking elongation is greater than or equal to 15%, the tensile property of the energy-ray-curable adhesive layer is excellent so that adhesive residue does not remain on a wafer, even when the radiation of the ultraviolet ray or other energy rays is not enough, and the energy-ray-curable adhesive layer is not fully cured.

The thickness of the energy-ray-curable adhesive layer, which is determined according to the required surface protection property for a semiconductor wafer or other adherends, is preferably in the range of 10 to 200 μm, and ideally in the range of 20 to 100 μm.

Next, the substrate is explained. The material for the substrate is not limited; for example, a polyethylene film, a polypropylene film, a polybutylene film, a polybutadiene film, a polymetylpentene film, a polyvinylchloride film, a polyvinylchloride copolymer film, a polyethylene terephthalate film, a polybutylene terephthalate film, a polyurethane film, an ethylene vinylacetate film, an ionomer resin film, an ethylene(meth)acrylic acid copolymer film, a polystyrene film, a polycarbonate film, a fluorocarbon resin film, and other films can be used. Further, crosslinked films or laminated films of these materials can also be used.

Note that the substrate needs to have transmittance for the wavelength range of the energy-ray in use. Therefore, for example, when an ultraviolet ray is used as an energy-ray, the substrate needs to have light transmittance. When an electron-beam is used, the substrate does not need to have light transmittance so that colored substrate may be used. The thickness of the substrate, which is adjusted according to the required properties of the adhesive sheet, is preferably in the range of 20 to 300 μm, and ideally in the range of 50 to 150 μm.

A release film for protecting the energy-ray-curable adhesive layer may be laminated onto the adhesive sheet of the present invention. A film of polyethylene terephthalate, polyethylene naphtahalate, polypropyrene, polyethyrene, or so on, may be used as the release film when the surface on one side of which is treated with a release agent of silicone resin or the like. However, the release film is not limited to those described above.

Next, the production method for the energy-ray-curable adhesives of the present invention is explained. Table 1 is a formulation table of energy-ray-curable urethane acrylates in working examples 1 to 12 and comparative examples 1 to 6 of energy-ray-curable adhesives. In Table 1, the number average molecular weight of each of the energy-ray-curable urethane acrylates, and each ratio (molar ratio) of polyisocyanates, polyols, and acrylates are represented.

TABLE 1

| | ENERGY- | | ENERGY-RAY-CURABLE URETHANE ACRYLATE | | | | | | | | | | |
|---|---|---|---|---|---|---|---|---|---|---|---|---|---|
| | RAY-CURABLE | | | NUMBER | | | | | | | | | |
| | ACRYLIC | | | AVERAGE | | | | | | | | | |
| | COPOLYMER | | | MOLECULAR | POLYISOCYANATE | | | POLYOL | | | | ACRYLATE | |
| | TYPE | AMOUNT | AMOUNT | WEIGHT | IPDI | H6XDI | H12MDI | PPG | PEG | PCDL | PTMG | 2HPA | 2HEA |
| WORKING | 1 | 100 | 10 | 5600 | 3 | — | — | 1.4 | 0.6 | — | — | 2 | — |
| EXAMPLE 1 | | | | | | | | | | | | | |
| WORKING | 1 | 100 | 10 | 5700 | 3 | — | — | 1.8 | 0.2 | — | — | 2 | — |
| EXAMPLE 2 | | | | | | | | | | | | | |
| WORKING | 1 | 100 | 10 | 4300 | 3 | — | — | 1.6 | 0.4 | — | — | 2 | — |
| EXAMPLE 3 | | | | | | | | | | | | | |
| WORKING | 1 | 100 | 10 | 4100 | 3 | — | — | 1.2 | 0.8 | — | — | 2 | — |
| EXAMPLE 4 | | | | | | | | | | | | | |
| WORKING | 1 | 100 | 10 | 5500 | 3 | — | — | 0.6 | 1.4 | — | — | 2 | — |
| EXAMPLE 5 | | | | | | | | | | | | | |
| WORKING | 1 | 100 | 10 | 5200 | 3 | — | — | 0.2 | 1.8 | — | — | 2 | — |
| EXAMPLE 6 | | | | | | | | | | | | | |
| WORKING | 2 | 100 | 10 | 5600 | 3 | — | — | 1.4 | 0.6 | — | — | 2 | — |
| EXAMPLE 7 | | | | | | | | | | | | | |
| WORKING | 2 | 100 | 10 | 5700 | 3 | — | — | 1.8 | 0.2 | — | — | 2 | — |
| EXAMPLE 8 | | | | | | | | | | | | | |
| WORKING | 2 | 100 | 10 | 4300 | 3 | — | — | 1.6 | 0.4 | — | — | 2 | — |
| EXAMPLE 9 | | | | | | | | | | | | | |
| WORKING | 2 | 100 | 10 | 4100 | 3 | — | — | 1.2 | 0.8 | — | — | 2 | — |
| EXAMPLE 10 | | | | | | | | | | | | | |
| WORKING | 2 | 100 | 10 | 5500 | 3 | — | — | 0.6 | 1.4 | — | — | 2 | — |
| EXAMPLE 11 | | | | | | | | | | | | | |
| WORKING | 2 | 100 | 10 | 5200 | 3 | — | — | 0.2 | 1.8 | — | — | 2 | — |
| EXAMPLE 12 | | | | | | | | | | | | | |
| COMPARATIVE | 1 | 100 | 10 | 6000 | 3 | — | — | 2 | — | — | — | 2 | — |
| EXAMPLE 1 | | | | | | | | | | | | | |
| COMPARATIVE | 1 | 100 | 10 | 6600 | 3 | — | — | — | 2 | — | — | 2 | — |
| EXAMPLE 2 | | | | | | | | | | | | | |
| COMPARATIVE | 1 | 100 | 10 | 6000 | — | — | 2 | — | — | — | 1 | — | 2 |
| EXAMPLE 3 | | | | | | | | | | | | | |
| COMPARATIVE | 1 | 100 | 10 | 9000 | — | 3 | — | — | — | 2 | — | — | 2 |
| EXAMPLE 4 | | | | | | | | | | | | | |
| COMPARATIVE | 2 | 100 | 10 | 6000 | — | — | 2 | — | — | — | 1 | — | 2 |
| EXAMPLE 5 | | | | | | | | | | | | | |
| COMPARATIVE | 2 | 100 | 10 | 9000 | — | 3 | — | — | — | 2 | — | — | 2 |
| EXAMPLE 6 | | | | | | | | | | | | | |

| | | | |
|---|---|---|---|
| WEIGHT | WEIGHT | — | MOLAR RATIO |
| PART | PART | | |

IPDI: ISOPHORONE DIISOCYANATE
H6XDI: 1,3-BIS(ISOCYANATOMETHYL)CYCLOHEXANE
H12MDI: DICYCLOHEXYLMETHANE 4,4′-DIISOCYANATE
PPG: POLYPROPYLENE GLYCOL
PEG: POLYETHYLENE GLYCOL
PCDL: POLYCARBONATE DIOL
PTMG: POLYTETRAMETHYLENE GLYCOL
2HPA: 2-HYDROXYPROPYL ACRYLATE
2HEA: 2-HYDROXYETHYL ACRYLATE

As main monomers, 73.2 weight parts of the butyl acrylate (BA), 10 weight parts of the dimethyl acrylamide (DMAA), 16.8 weight parts of the 2-hydroxyethyl acrylate (2HEA) as a functional monomer, were solution-polymerized in a solvent of ethyl acetate. As a result, the acrylic copolymer was generated with a weight average molecular weight of 500,000 and glass transition temperature of −10 degrees Celsius. Then, 100 weight parts of the solid content of the acrylic copolymer, and 18.7 weight parts of methacryloyl oxyethyl isocyanate (MOI, 83 equivalents per 100 equivalents of the functional group of the acrylic copolymer) as an unsaturated compound (a monomer having an unsaturated group) were mixed together and diluted by ethyl acetate to create a reaction producing the Type 1 energy-ray-curable acrylic copolymer as a solution (30 percent solution) in the ethyl acetate.

To form the energy-ray-curable urethane acrylate of the working example 1, 3 weight parts of an isophorone diisocyanate (IPDI) to form a polyisocyanate unit, 1.4 weight parts of a polypropylene glycol (PPG) and 0.6 weight parts of a polyethylene glycol (PEG) to form a polyol unit were polymerized in a solvent of ethyl acetate. Later, 2 weight parts of a 2-hydroxypropyl acrylate (2HPA) as an acrylate was further mixed, and dibutyl tin laurylate as a reaction promoter was added and mixed together to create a reaction producing the energy-ray-curable urethane acrylate as a solution (70 percent solution) in the ethyl acetate.

To the 100 weight parts of the above-explained energy-ray-curable acrylic copolymer, 0.37 weight parts (solid content ratio) of the polyisocyanate compound CL (“Colonate L”, trade name of a product of NIPPON POLYURETHANE INDUSTRY CO., LTD.) as a crosslinking agent, and 3.3 weight parts (solid content ratio) of a photopolymerization initiator PI (IRGACURE 184, trade name of a product of Ciba Specialty Chemicals K. K.) were mixed therein, and further, 10 weight parts (solid content ratio) of the energy-ray-curable urethane acrylate was added thereto, thus obtaining the energy-ray-curable adhesive of working example 1.

The energy-ray-curable adhesive was applied with a roll knife coater onto the surface of a release film whose surface had been release-treated with a silicone resin. Then, the energy-ray-curable adhesive and the release film were dried for one minute at 100 degrees Celsius to make the thickness of the energy-ray-curable adhesive 40 μm . Later on, the energy-ray-curable adhesive was laminated onto a substrate of polyethylene film with a thickness of 110 μm, thus resulting in the adhesive sheet of working example 1 that includes the energy-ray-curable urethane acrylate whose formulation is represented in Table 1, in the energy-ray-curable adhesive layer.

Note that in working examples 2 to 12 and comparative examples 1 to 6, adhesive sheets were obtained by the same method as that of working example 1, other than the differences among formulations in the energy-ray-curable urethane acrylates as represented in Table 1. Note that the Type 2 energy-ray-curable acrylic copolymer in working examples 7 to 12 and comparative examples 5 and 6, was formed similarly to the Type 1 energy-ray-curable acrylic copolymer except for the following differences. That is, the Type 2 energy-ray-curable acrylic copolymer was formed using 52 weight parts of the butyl acrylate (BA) and 20 weight parts of the methyl methacrylate (MMA) as main monomers, 28 weight parts of the 2-hydroxyethyl acrylate (2HEA) as a functional monomer, and then reacting 33.7 weight parts of methacryloyl oxyethyl isocyanate (MOI, 90 equivalents per 100 equivalents of the functional group of the acrylic copolymer).

Next, the evaluation test results for the energy-ray-curable adhesives and the adhesive sheets of the working examples and comparative examples are explained. Table 2 represents the evaluation test results for the energy-ray-curable adhesives and the adhesive sheets of working examples and comparative examples.

TABLE 2

| | | | | | TENSILE PROPERTY | | | |
|---|---|---|---|---|---|---|---|---|
| | | | VISCOELASTICITY | | REPTURE | BREAKING | | |
| | COMPATIBILITY | | G′ | | STRESS | ELONGATION | RESIDUAL | FOLLOWABILITY |
| | VISUAL | HAZE | MPa | tan δ | MPa | % | ADHESIVE | TO UNEVENESS |
| WORKING | ⊚ | 0.89 | 0.050 | 0.580 | 17.29 | 40.91 | ⊚ | ◯ |
| EXAMPLE 1 | | | | | | | | |
| WORKING | ⊚ | 0.77 | 0.032 | 0.650 | 10.73 | 24.17 | ◯ | ◯ |
| EXAMPLE 2 | | | | | | | | |
| WORKING | ⊚ | 0.84 | 0.051 | 0.607 | 10.99 | 35.72 | ◯ | ◯ |
| EXAMPLE 3 | | | | | | | | |
| WORKING | ⊚ | 1.14 | 0.038 | 0.234 | 10.66 | 30.52 | ◯ | ◯ |
| EXAMPLE 4 | | | | | | | | |
| WORKING | ⊚ | 1.15 | 0.064 | 0.490 | 13.86 | 29.39 | ◯ | ◯ |
| EXAMPLE 5 | | | | | | | | |
| WORKING | ⊚ | 1.69 | 0.086 | 0.435 | 13.86 | 28.75 | ◯ | ◯ |
| EXAMPLE 6 | | | | | | | | |
| WORKING | ⊚ | 1.09 | 0.120 | 0.720 | 26.20 | 25.10 | ⊚ | ◯ |
| EXAMPLE 7 | | | | | | | | |
| WORKING | ⊚ | 0.85 | 0.067 | 0.720 | 12.30 | 16.30 | ◯ | ◯ |
| EXAMPLE 8 | | | | | | | | |
| WORKING | ⊚ | 1.05 | 0.063 | 0.400 | 23.90 | 17.40 | ◯ | ◯ |
| EXAMPLE 9 | | | | | | | | |
| WORKING | ⊚ | 0.98 | 0.041 | 0.650 | 11.55 | 20.50 | ◯ | ◯ |
| EXAMPLE 10 | | | | | | | | |
| WORKING | ⊚ | 1.02 | 0.069 | 0.670 | 15.49 | 16.85 | ◯ | ◯ |
| EXAMPLE 11 | | | | | | | | |
| WORKING | ⊚ | 1.43 | 0.079 | 0.660 | 17.65 | 17.69 | ◯ | ◯ |
| EXAMPLE 12 | | | | | | | | |
| COMPARATIVE | ⊚ | 0.39 | 0.061 | 0.482 | 10.44 | 22.31 | Δ | ◯ |
| EXAMPLE 1 | | | | | | | | |
| COMPARATIVE | ⊚ | 0.87 | 0.070 | 0.462 | 14.50 | 29.11 | Δ | ◯ |
| EXAMPLE 2 | | | | | | | | |
| COMPARATIVE | X | 4.50 | 0.096 | 0.620 | 9.42 | 13.30 | X | ◯ |
| EXAMPLE 3 | | | | | | | | |
| COMPARATIVE | X | 2.47 | 0.063 | 0.630 | 8.62 | 10.53 | X | ◯ |
| EXAMPLE 4 | | | | | | | | |
| COMPARATIVE | X | 6.21 | 0.080 | 0.630 | 7.47 | 6.59 | X | ◯ |
| EXAMPLE 5 | | | | | | | | |
| COMPARATIVE | X | 3.00 | 0.050 | 0.530 | 9.56 | 13.25 | X | ◯ |
| EXAMPLE 6 | | | | | | | | |

Haze: The adhesive sheets of the working and comparative examples used in the haze evaluation tests were formed by the same method as that explained above, except for the use of a polyester film with thickness of 100 μm instead of a substrate.

The release films were removed from the adhesive sheets, and the hazes of these sheets were measured at the adhesive surface of the energy-ray-curable adhesive layers, based on JIS K7105.

Visual: The appearance of the energy-ray-curable adhesive layers of the adhesive sheets for evaluating haze was observed visually.

⊚: No indication of separation or turbidity (nebula) at all

◯: Slight indication of turbidity

×: Strong indication of turbidity or separation

Storage modulus G′ and tan δ:Adhesive sheets of the working and comparative examples were obtained by the same production method as explained previously, with the difference being the use of two release films for protecting the exposed surfaces. These adhesive sheets include only the energy-ray-curable adhesives, with the substrate having been omitted. These adhesive sheets were piled after the release films thereof were removed, so that the energy-ray-curable adhesive layer had a thickness of approximately 4 mm. Then, the energy-ray-curable adhesive layer of a cylindrical shape with an 8 mm diameter was punched from the piled adhesive sheets, in order to evaluate viscoelasticity.

The storage modulus G′ at 25 degrees Celsius and the values of tan 6 of these test materials were measured by a viscoelasticity measuring device (DYNAMIC ANALYZER RDA II manufactured by REOMETRIC SCIENTIFIC F. E. LTD.).

Rupture stress and breaking elongation: Test materials having a width of 15 mm, a thickness of 0.2 mm, and a total length of 150 mm (the distance between chucks being 100 mm) were prepared from the energy-ray-curable adhesives of working and comparative examples that had no substrate and that were in the cured state (cured by irradiation with an ultraviolet ray (radiation condition: illuminance 350 mW/cm², amount of radiation 200 mJ/cm²)). Then, the rupture stress (MPa) and breaking (%) were measured to evaluate the tensile property, based on JIS 7127.

Residual adhesive: After followability to the uneven circuit surface was evaluated, the rear surface of the wafers were ground down to the thickness of a 100 μm by a wafer rear-surface grinding device (DGP8760 manufactured by DISCO CORPORATION). Then, an ultraviolet ray as an energy-ray was irradiated to the surface of the adhesive sheet (radiation condition: illuminance 350 mW/cm², light quantity 200 mJ/cm²) by a tape mounter (RAD-2700F/12 manufactured by LINTEC Corporation) which has devices for radiating an ultraviolet ray and peeling a tape. After that, a transcription tape (Adwill D-175 manufactured by LINTEC Corporation) was laminated on the grinding surface of the wafer, and the adhesive sheet was removed. The exposed uneven circuit patterns were then observed through a microscope (digital microscope VHX-200 manufactured by KYENCE CORPORATION) at 2000 magnification. Based on observation results, an evaluation of foreign matter and residual adhesive was made and noted with following symbols.

⊚: No indication of residual adhesive at all

◯: Slight indication of residual adhesive, the sheet still usable as an adhesive sheet

Δ: Some indication of residual adhesive

×: Strong indication of residual adhesive

Followability to circuit : Dummy wafers were prepared with circuit patterns having a maximum height difference of 20 μm on a silicone wafer (diameter:200 mm, thickness:750 μm). The adhesive sheets of the working and comparative examples were laminated to the circuit surfaces of the dummy wafers by a tape laminator (RAD-3500F/12 manufactured by LINTEC Corporation). The circuit pattern surfaces of the dummy wafers were observed from the side of the substrate of the adhesive sheet through a microscope (digital microscope VHX-200 manufactured by KEYENCE CORPORATION) at 2000 magnification. When air (a bubble) was not detected between the adhesive sheet and the circuit pattern surface around the uneven circuit patterns in the observation area, it was judged that the adhesive sheet had maintained followability with respect to the circuit (marked ◯). On the other hand, when air (a bubble) was detected, it was judged that the adhesive sheet had not maintained followability with respect to the circuit (marked ×).

Regarding the compatibility, as is clear from Table 2, the energy-ray-curable adhesives of working examples 1 to 12 and comparative examples 1 and 2 have superior compatibility between the energy-ray-curable urethane acrylate and the energy-ray-curable acrylic copolymer to those of comparative examples 3 to 6. This is because the working examples 1 to 12 and comparative examples 1 and 2 show better evaluation results and smaller haze values, than other comparative examples. Therefore, it is clear that the working examples 1 to 12 and some comparative examples have excellent compatibility between the energy-ray-curable urethane acrylate and the energy-ray-curable acrylic copolymer. This is expected because PPG and PEG, which are similar polyol components, are used (see Table 1), and an isophorone diisocyanate (IPDI) is used as an isocyanate unit (see Table 1) in the working examples 1 to 12 and other examples.

Because in all working examples 1 to 12, the storage moduli G′ at 25 degrees Celsius are lower than or equal to 0.15 MPa, and the values of tan δ are greater than or equal to 0.2 (see Table 2), these energy-ray-curable adhesives have sufficient viscoelasticity, adhesion strength in the non-cured state, and followability to the uneven circuit surface.

Furthermore, as is clear from Table 2, the energy-ray-curable adhesives of working examples 1 to 12 have excellent tensile property in the cured state. This is because that the rupture stresses of these energy-ray-curable adhesive layers in the cured state are greater than or equal to 10 MPa, their breaking elongations are greater than or equal to 15%, and these values are greater than those of the comparative examples 3 to 6. The difference of the rupture stress and breaking elongation among the working examples 1 to 12, is explained below.

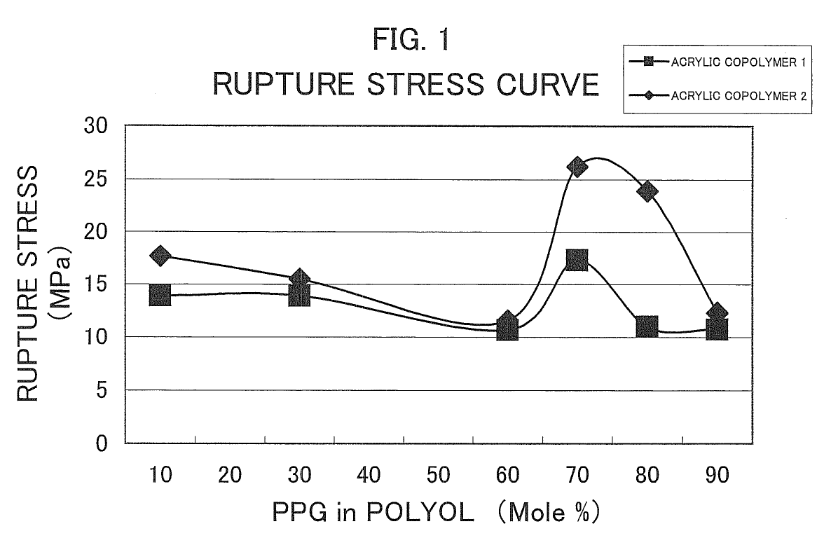

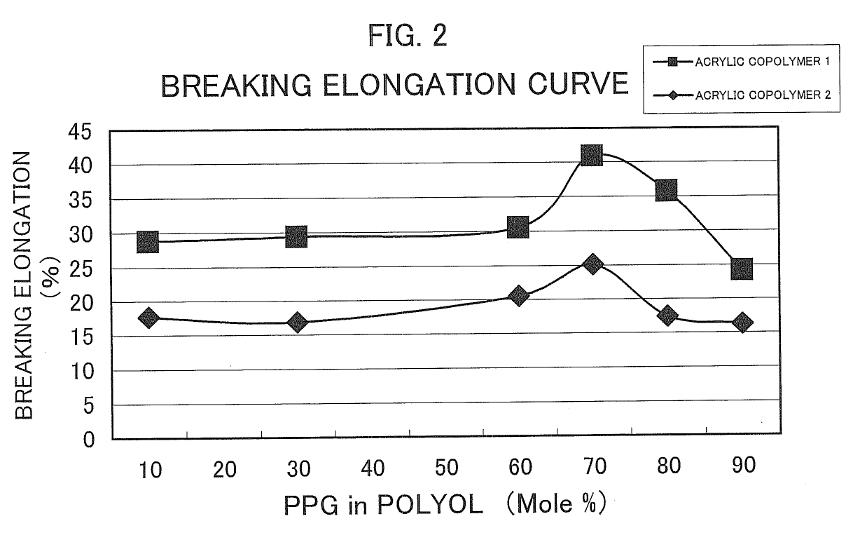

FIG. 1 is a graph representing the relationship between the ratio of the PPG (polypropylene glycol) in polyols included in the energy-ray-curable urethane acrylates of the working examples, and the rupture stress (MPa) of the energy-ray-curable adhesive layers. FIG. 2 is a graph representing the relationship between the ratio of the PPG (polypropylene glycol) in polyols included in the energy-ray-curable urethane acrylates of the working examples, and the breaking elongation (%) of the energy-ray-curable adhesive layers.

When the ratio of the PPG in the polyols is between 10 and 90 mole percent, that is, when the PPG and PEG monomers are copolymerized in the range of the molar ratio between 1:9 and 9:1 (the working examples 1 to 12, see Table 1), the values of the rupture stress (MPa) and breaking elongation (%) tend to be greater than those values when only one of the PPG and PEG monomers is used (the comparative examples 1 and 2, see Table 1). This is expected due to the effect of combining the PEG with higher crystallinity due to a lack of a branched chain, and the PPG with lower crystallinity due to branched chains.

As is clear from FIGS. 1 and 2, when the molar ratio of the PPG and PEG is around between 9:1 and 1:4, that is, when the PPG content in the polyols is around between 20 and 90 mole percent (the working examples 1 to 5 and 7 to 11, see Table 1), the values of the rupture stress (MPa) and breaking elongation (%) tend to be more greater than other area in the PPG content. Especially, when the molar ratio of the PPG and PEG is around between 4:1 and 3:2, that is, when the PPG content in the polyols is between 60 and 80 mole percent (the working examples 1, 3, 4, 7, 9, and 10; see Table 1), the values of the rupture stress (MPa) and breaking elongation (%) are great. In this range, when the molar ratio of the PPG and PEG is between 7.5:2.5 and 6.5:3.5, especially when it is 7:3 (the working examples 1 and 7, see Table 1), the values of the rupture stress (MPa) and breaking elongation (%) are almost maximal. As a result, it is clear that the energy-ray-curable adhesive in which the PPG and PEG are used in this molar ratio, have a particularly good tensile property.

The working examples 1 and 7 show the especially excellent results for residual adhesive (see Table 2). This is expected because the energy-ray-curable adhesive of these working examples have an excellent tensile property, in addition to sufficient compatibility thereof. That is, when the adhesive sheets of these working examples which have an excellent tensile property are removed from a circuit surface of a wafer, the energy-ray-curable adhesive layer is not broken or left on the wafer as residue.

In the present embodiment, as explained above, using both the PPG and PEG to form a polyol unit included in the energy-ray-curable urethane acrylate, an adhesive sheet with excellent followability to unevenness such as an uneven circuit surface of a wafer, good compatibility among its ingredients, and a satisfactory tensile property so as not to generate an adhesive residue, can be realized.

Note that materials of the components consisting of the adhesive sheet are not limited to those exemplified in the embodiment. For example, polyols having similar molecular structure to those of PPG or PEG may be copolymerized in a suitable ratio such as that explained above, to form a polyol unit. Furthermore, the PPG and PEG monomers used in the above-explained suitable ratio, and other exemplified polyols (for example, see lines 15 of page 11 to line 6 pf page 12), may be copolymerized to form a polyol unit. The purpose of such an adhesive sheet is not limited to the protection of a semiconductor wafer undergoing the DBG process, but may also be the protection of a semiconductor wafer undergoing a conventional process, or the protection of the surface of a workpiece other than a semiconductor.

This invention is not limited to that described in the preferred embodiment, namely, various improvements and changes may be made to the present invention without departing from the spirit and scope thereof.

The present disclosure relates to subject matter contained in Japanese Patent Applications No. 2007-293329 (filed on Nov. 12, 2007) and No. 2008-273282 (filed on October 23, 2008) which are expressly incorporated herein, by reference, in their entirety.

1. An adhesive sheet comprises:
a substrate; and
an energy-ray-curable adhesive layer formed on said substrate,
said energy-ray-curable adhesive layer comprising an energy-ray-curable acrylic copolymer and an energy-ray-curable urethane acrylate, said energy-ray-curable acrylic copolymer comprising a side chain with an unsaturated group, said energy-ray-curable urethane acrylate comprising an isocyanate unit, a polyol unit, and a (meth)acryloyl group, said polyol unit comprising a plurality of types of polyols.

2. The adhesive sheet according to claim 1, wherein said polyols comprise a polypropylene glycol and a polyethylene glycol.

3. The adhesive sheet according to claim 2, wherein the molar ratio of said polypropylene glycol and said polyethylene glycol is between 9:1 and 1:9.

4. The adhesive sheet according to claim 3, wherein the molar ratio of said polypropylene glycol and said polyethylene glycol is between 9:1 and 1:4.

5. The adhesive sheet according to claim 1, wherein the rupture stress of said energy-ray-curable adhesive layer is greater than or equal to 10 MPa and the breaking elongation of said energy-ray-curable adhesive layer is greater than or equal to 15%, when said energy-ray-curable adhesive layer is cured by energy-rays.
